(19) United States
(12) Patent Application Publication
(10) Pub. No.: US 2013/0339362 A1
(43) Pub. Date: Dec. 19, 2013

(54) METHODS AND SYSTEMS FOR AUTOMATICALLY AND EFFICIENTLY CATEGORIZING, TRANSMITTING, AND MANAGING MULTIMEDIA CONTENTS

(71) Applicant: En-hui Yang, Petersburg (CA)

(72) Inventor: En-hui Yang, Petersburg (CA)

(21) Appl. No.: 13/918,030

(22) Filed: Jun. 14, 2013

Related U.S. Application Data
(60) Provisional application No. 61/660,258, filed on Jun. 15, 2012.

(51) Int. Cl. G06F 17/30

(52) U.S. Cl. CPC G06F 17/30017
USPC 707/738

(57) ABSTRACT

Methods and systems for automatically and efficiently categorizing, securely transmitting, and managing multimedia contents generated from a network connection enabled digital data generating device by way of multimedia transcoding, compression, and/or classification. Content similarity between multimedia data units with one unit corresponding to one image, one video frame, or one audio frame is first detected and identified, and then used to help encode conditionally one unit given another. Based on the identified content similarity and/or the resulting compression efficiency, these multimedia units are automatically categorized in terms of their contents along with their locations, occasions, events, and/or features. Whenever network connections selected by a user are available, these encoded and categorized multimedia data units along with their metadata containing side information including their locations, occasions, events, features, and other information specified by the user are then automatically and securely transmitted to networks, cloud servers, and/or other network connected devices.

### CROSS-REFERENCE TO RELATED APPLICATIONS

This application claims the benefit of priority to U.S. Provisional Patent Application No. 61/660,258 filed Jun. 15, 2012, the contents of which are hereby incorporated by reference.

### TECHNICAL FIELD

At least some example embodiments generally relate to automatic categorization, transmission, and management of multimedia contents, and in particular to methods and systems that automatically and efficiently categorize multimedia contents.

### BACKGROUND

The convergence of wireless communications and mobile computing is happening at a speed much faster than most of us have anticipated. According to a white paper from Cisco entitled “Cisco Visual Networking Index: Global Mobile Data Traffic Forecast Update, 2011-2016” (since updated on Feb. 6, 2013 for 2012-2017), the global mobile data traffic in 2011 was 597 petabytes per month, more than eight times the size of the entire global Internet traffic in 2000; again in 2011, the mobile data traffic originating from phones and tablets was 217 petabytes per month, more than 36% of the entire global mobile data traffic. It is expected that the number of mobile-connected devices will soon exceed the world's population. With so many mobile-connected devices, both downlink mobile data traffic and uplink mobile data traffic, particularly multimedia traffic including photos and videos generated by users themselves, will continue to grow phenomenally.

Although the proliferation of high-end smartphones, tablets, network connection enabled digital cameras and camcorders, and other high-end network connection enabled devices makes it easy for users to generate multimedia contents such as photos, videos, and audios, managing these data and moving them onto networks, cloud servers, home and office computers, and/or other network connected devices is quite challenging at this point. Part of the reason lies in the huge volume of these data; part of the reason lies in the fact that these data are in general unstructured. For example, on tablets, smartphones, and digital cameras, photos, right after being captured, are normally saved separately as independent files, one photo per file, indexed sequentially according to the order they were taken, and named with their respective indices and possibly along with information on the location and time at which they were taken. As clearly illustrated in FIG. 1, a screen shot taken from a Mac Pro™ computer, these independent files are stored in an unorganized structure. To move these photos from their network connection enabled generating device onto networks, cloud servers, home and office computers, and/or other network connected devices, users could manually do one of the following:

(1) open a client application on the generating device and then send/upload these photos via the client application to their desired destinations, or

(2) use a cable such as a universal serial bus to connect the generating device to a personal computer (PC) or take a memory stick out from the generating device and plug it into the PC, and then upload these photos to the PC and other desired destinations.

Clearly, none of the above approaches is convenient.

### BRIEF DESCRIPTION OF THE DRAWINGS

Reference will now be made, by way of example, to the accompanying drawings which show example embodiments, in which:

FIG. 1 illustrates an example user interface screen for photo organization;

FIG. 2A illustrates an example user interface screen which illustrates photo structure for a mobile communication client device;

FIG. 2B illustrates an example user interface screen which illustrates a corresponding photo structure for a server device;

FIG. 3 illustrates a flow diagram of a first example method for managing multimedia content of a device, illustrating a categorization only procedure, in accordance with an example embodiment;

FIG. 4 illustrates a flow diagram of a second example method for managing multimedia content of a device, illustrating a categorization and compression procedure, in accordance with an example embodiment;

FIG. 5 illustrates a flow diagram of a third example method for managing multimedia content of a device, illustrating a categorization and lossless compression procedure, in accordance with an example embodiment;

FIG. 6 illustrates a block diagram of a system for managing multimedia content of a device, to which example embodiments may be applied;

FIG. 7 illustrates a block diagram of a simplified system for managing multimedia content of a device, to which example embodiments may be applied;

FIG. 8 illustrates a block diagram of a JPEG encoder, to which example embodiments may be applied;

FIG. 9 illustrates an algorithm of the first example method of FIG. 3, in accordance with an example embodiment;

FIG. 10 illustrates an algorithm of the second example method of FIG. 4, in accordance with an example embodiment; and

FIG. 11 illustrates an algorithm of the first example method of FIG. 5, in accordance with an example embodiment.

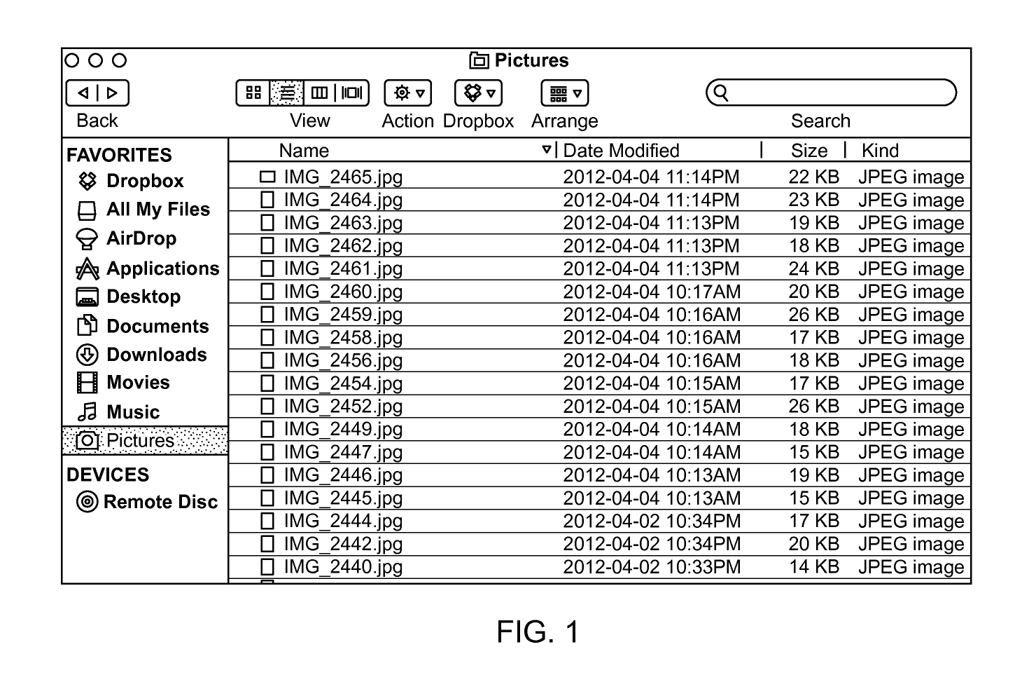

Similar reference numerals may be used in different figures to denote similar components.

### DETAILED DESCRIPTION OF EXAMPLE EMBODIMENTS

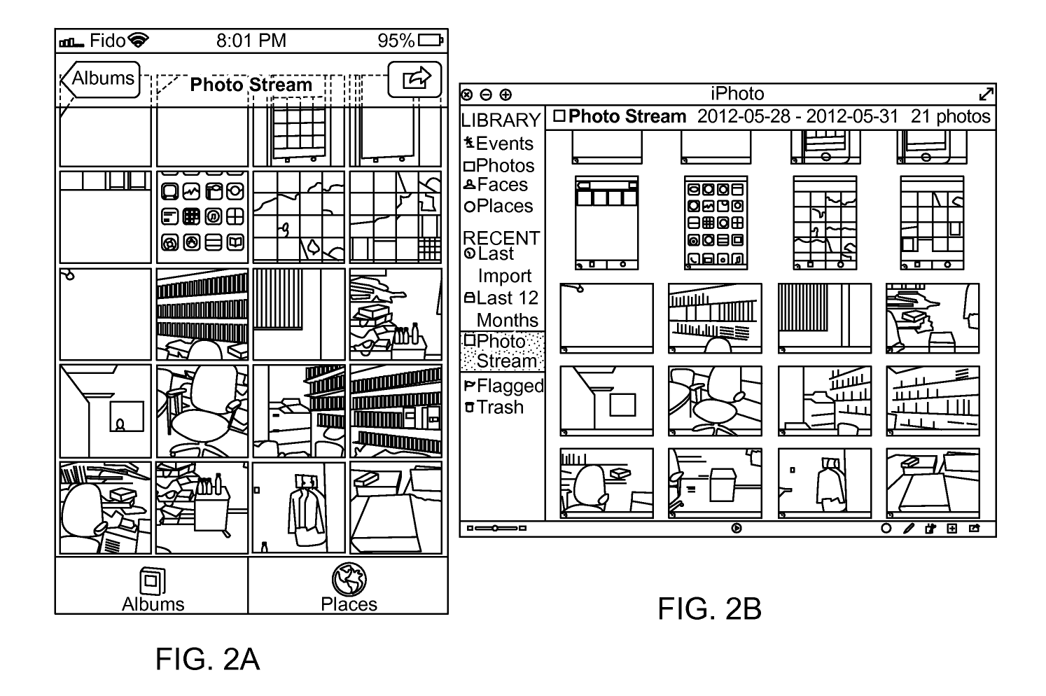

To overcome the inconvenience problem associated with manual operations, recent wireless sync services such as iCloud™, Dropbox™, Google+™, Skydrive™, etc., can automatically upload photos from a specific folder on a smartphone to a cloud server. For example, the Photo Stream™ service of iCloud automatically uploads a newly taken photo stored in the special folder, Photo Stream™, on an iOS™ device (developed and distributed by Apple Inc.), to a cloud server and also pushes it to users' other registered devices and computers over any available Wi-Fi or Ethernet connection. However, as clearly illustrated in FIGS. 2A and 2B, screen shots of Photo Stream on an iPhone™ and iCloud, photos in Photo Stream remain unstructured and unorganized as independent files; they are not automatically categorized either in terms of their contents, locations, occasions, events, and/or features. In addition, the wireless sync services may not be power efficient, bandwidth efficient, and/or storage efficient since similarity between photos taken consecutively at the same scene, location, or event is not utilized to further reduce the size of these photos.

It would be advantageous to have methods and systems that automatically and efficiently categorize multimedia contents generated from a network connection enabled digital data generating device in terms of their contents, locations, occasions, events, and/or features, securely transmit them to other network connected devices, and manage them across all these devices.

At least some example embodiments generally relate to automatic categorization, transmission, and management of multimedia contents, and in particular to methods and systems that automatically and efficiently categorize multimedia contents generated from a network connection enabled digital data generating device in terms of their contents, locations, occasions, events, and/or features, securely transmit them to other network connected devices, and manage them across all these devices.

In at least some example embodiments, there is provided methods and systems for automatically and efficiently categorizing, securely transmitting, and managing multimedia contents generated from a network connection enabled digital data generating device by way of multimedia transcoding, compression, and/or classification. Content similarity between multimedia data units with one unit corresponding to one image, one video frame, or one audio frame is first detected and identified, and then used to help encode conditionally one unit given another; based on the identified content similarity and/or the resulting compression efficiency, these multimedia units are automatically categorized in terms of their contents along with their locations, occasions, events, and/or features; whenever network connections selected by a user are available, these encoded and categorized multimedia data units along with their metadata containing side information including their locations, occasions, events, features, and other information specified by the user are then automatically and securely transmitted to networks, cloud servers, and/or home and office computers, and are further pushed to other network connected devices. Depending on the availability of network connections and the power supply of the digital data generating device, the detection and identification of content similarity, encoding, categorization, and transmission can be performed either concurrently or sequentially. Further management performed on the cloud servers, home computers, and/or office computers regarding amalgamation, regrouping, decoupling, insertion, deletion, etc. of these encoded and categorized multimedia data units will be pushed to all connected devices mentioned above to keep them in sync with a service agreement.

To be specific, at least some example embodiments can use images such as photos and medical images as exemplary multimedia contents to illustrate our example methods and systems that automatically and efficiently categorize multimedia contents generated from a network connection enabled digital data generating device in terms of their contents, locations, occasions, events, and/or features, securely transmit them to other network connected devices, and manage them across all these devices. Nonetheless, at least some example embodiments of the methods and systems apply to other multimedia content types such as video and audio as well with one image replaced by one multimedia data unit, which is a video frame in the case of video and an audio frame in the case of audio.

On many occasions, a user of a network connection enabled digital data generating device may take a sequence of images consecutively at the same scene, location, and/or event. These images are often compressed already in an either lossless or lossy manner by standard compression methods such as JPEG (e.g. G. K. Wallace, “The JPEG still picture compression standard,” Communications of the ACM, Vol. 34, No. 4, pp. 3044, April, 1991) when they are captured by the digital data generating device. As such, using universal lossless compression algorithms, such as the Lempel-Ziv algorithms (e.g. J. Ziv and A. Lempel, “A universal algorithm for sequential data compression,” IEEE Trans. Inform. Theory, vol. 23, pp. 337-343, 1977; and J. Ziv and A. Lempel, “Compression of individual sequences via variable rate coding,” IEEE Trans. Inform. Theory, vol. 24, pp. 530-536, 1978); and the Yang-Kieffer grammar-based algorithms (J. C. Kieffer and E.-H. Yang, “Grammar based codes: A new class of universal lossless source codes,” IEEE Trans. Inform. Theory, vol. 46, pp. 737-754, 2000; E.-H. Yang and J. C. Kieffer, “Efficient universal lossless data compression algorithms based on a greedy sequential grammar transform-Part one: Without context models,” IEEE Trans. Inform. Theory, vol. 46, pp. 755-788, 2000; and E.-H. Yang and Da-ke He, “Efficient universal lossless compression algorithms based on a greedy sequential grammar transform-Part two: With context models,” IEEE Trans. Inform. Theory, Vol. 49, No. 11, pp. 2874-2894, November 2003) directly to further compress them either individually or collectively yields little or no compression. On the other hand, since these images are taken at the same scene, location, and/or event, some of them do look similar. In at least some systems of example embodiments, the content similarity between images is first detected and identified, and then used to help encode or re-encode conditionally one image given another image; based on the identified content similarity and/or the resulting compression efficiency, these images are automatically categorized in terms of their contents along with their locations, occasions, events, and/or features; whenever network connections selected by a user are available, these encoded and categorized images along with their metadata containing side information including their locations, occasions, events, features, and other information specified by the user are then automatically and securely transmitted to networks, cloud servers, and/or home and office computers, and are further pushed to other network connected devices. Depending on the availability of network connections and the power supply of the digital data generating device, the detection and identification of content similarity, encoding, categorization, and transmission can be performed either concurrently or sequentially. Further management performed on the cloud servers, home computers, and/or office computers regarding amalgamation, regrouping, decoupling, insertion, deletion, etc. of these encoded and categorized images will be pushed to all connected devices mentioned above to keep them in sync with a service agreement.

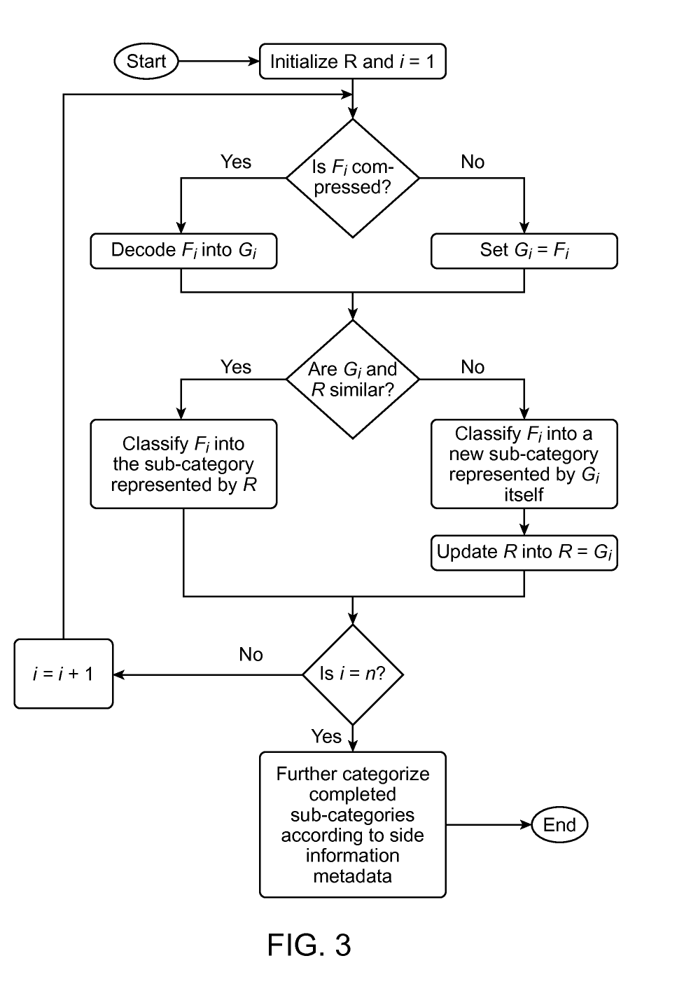

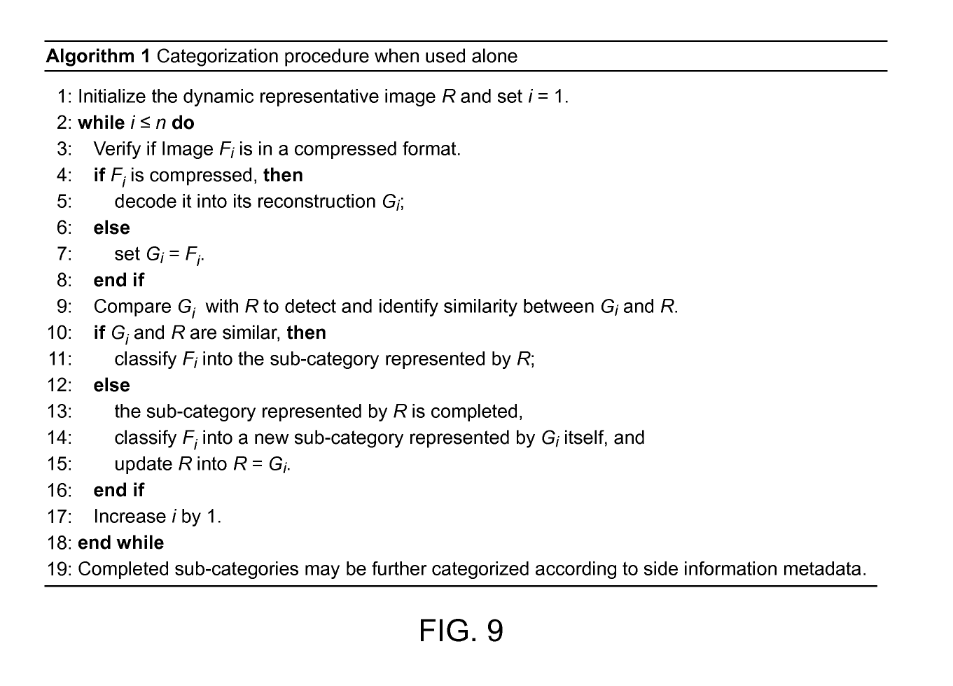

Let F₁, F₂, . . . , Fᵢ, . . . , Fₙ be a sequence of images captured consecutively by the digital data generating device in the indicated order. As the image index i increases, the content similarity in these images likely appears in a piece-wise manner since images appearing consecutively according to i are likely taken at the same scene, location, and/or event. Taking advantage of this feature, the example embodiments of the described methods and systems process these images in an image by image manner while always maintaining a dynamic representative image R. Initially, the representative image R could be a blank image or the representative image left at the end of the earlier session of the systems. The categorization procedure, when used alone, is described in Algorithm 1 shown in FIG. 9 and further illustrated in the flowchart shown in FIG. 3.

In Algorithm 1, initialize the dynamic representative image R and set i=1. Perform the Algorithm while i≦n. Verify if Image Fᵢ is in a compressed format: if Fᵢ is compressed, then decode it into its reconstruction Gᵢ; else set Gᵢ=Fᵢ. Compare Gᵢ with R to detect and identify similarity between Gᵢ and R: if Gᵢ and R are similar, then classify Fᵢ into the sub-category represented by R; else the sub-category represented by R is completed, classify Fᵢ into a new sub-category represented by Gᵢ itself, and update R into R=Gᵢ. Increase i by 1. Completed sub-categories may be further categorized according to side information metadata.

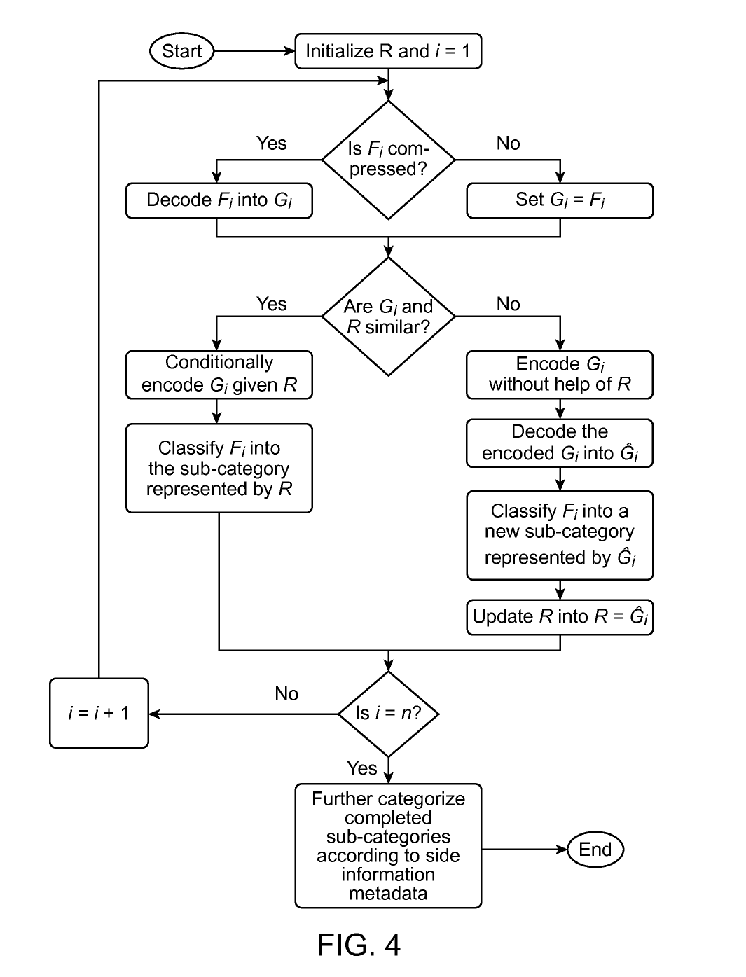

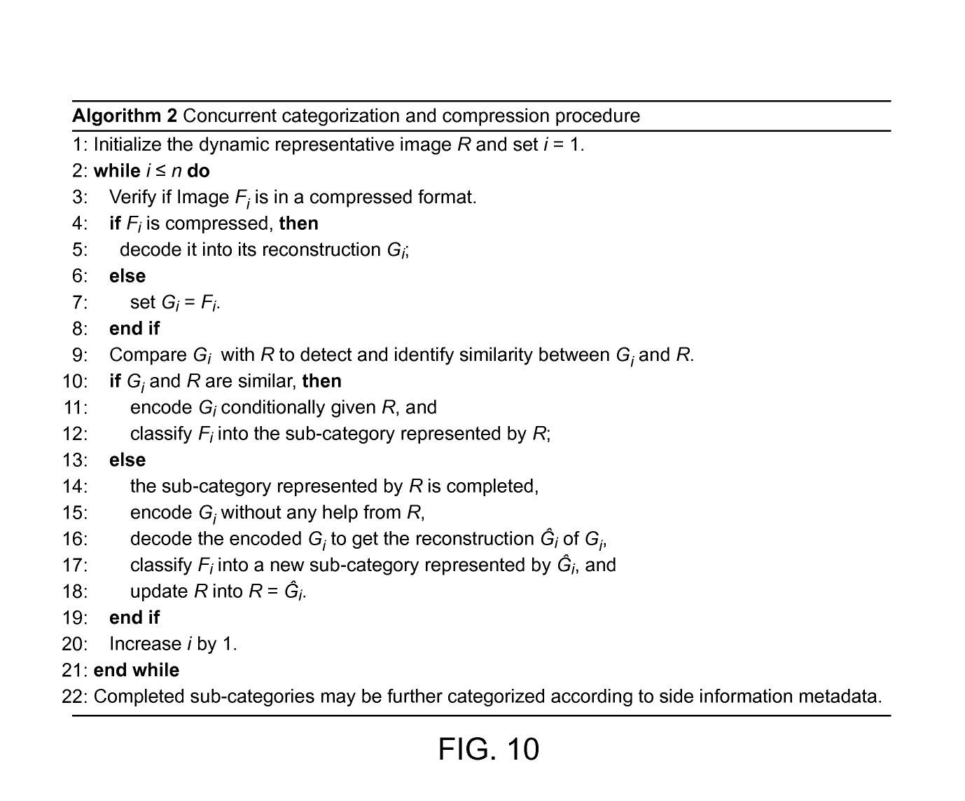

To improve bandwidth efficiency, storage efficiency, and/or radio power efficiency needed for wireless transmission, the categorization procedure described in Algorithm 1 can also be used in conjunction with conditional compression. The resulting concurrent categorization and compression procedure is described in Algorithm 2 shown in FIG. 10 and further illustrated in the flowchart shown in FIG. 4.

In Algorithm 2, initialize the dynamic representative image R and set i=1. Perform the Algorithm while i≦n. Verify if Image Fⁱ is in a compressed format: if Fᵢ is compressed, then decode it into its reconstruction Gᵢ; else set Gᵢ=Fᵢ. Compare Gᵢ with R to detect and identify similarity between Gᵢ and R: if Gᵢand R are similar, then encode Gᵢ conditionally given R, and classify Fᵢ into the sub-category represented by R; else the sub-category represented by R is completed, encode Gᵢ without any help from R, decode the encoded Gᵢ to get the reconstruction Ĝᵢ of Gᵢ, classify Fᵢ into a new sub-category represented by Ĝᵢ, and update R into R=Ĝᵢ. Increase i by 1. Completed sub-categories may be further categorized according to side information metadata.

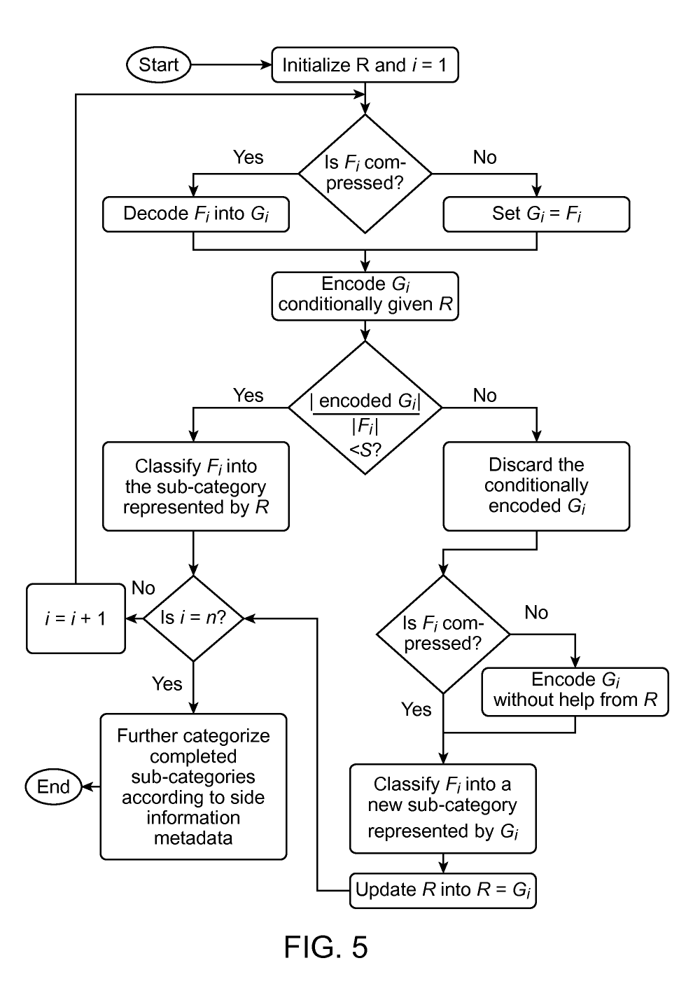

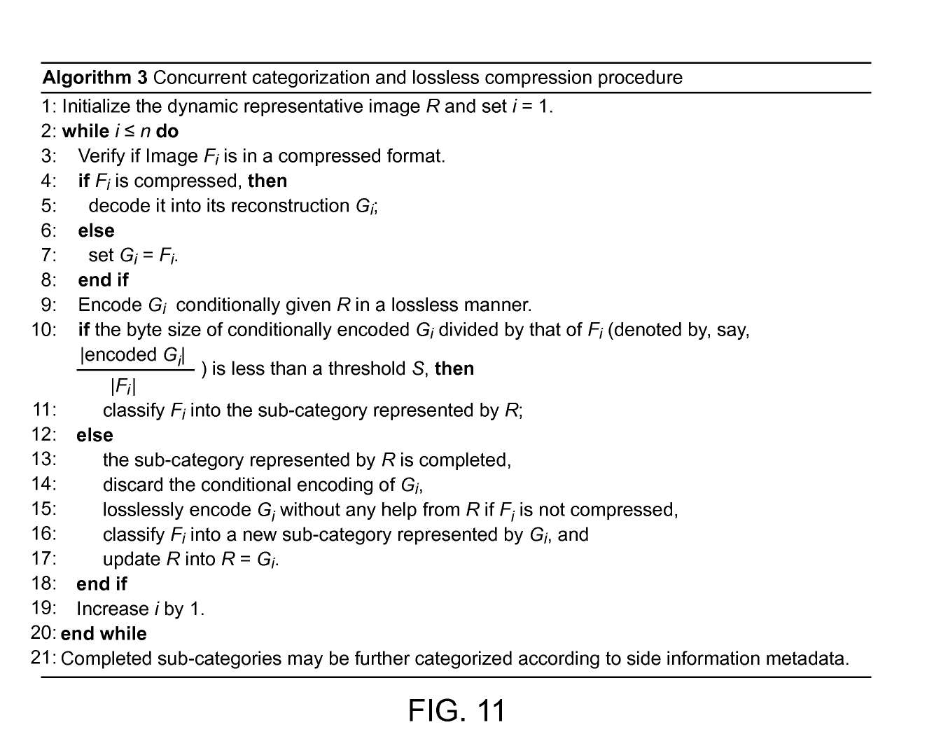

The encoding of each Gᵢ in Algorithm 2 can be either lossless or lossy. If it is lossless, the classification of each image Fᵢ into each sub-category represented by R can also be determined according to the efficiency of conditional encoding of Gᵢ given R in comparison with the original file size of Fᵢ. Such a variant of concurrent categorization and lossless compression procedure is described in Algorithm 3 shown in FIG. 11 and further illustrated in the flowchart shown in FIG. 5.

In Algorithm 3, initialize the dynamic representative image R and set i=1. Perform the Algorithm while i≦n. Verify if Image Fᵢ is in a compressed format: if Fᵢ is compressed, then decode it into its reconstruction Gᵢ; else set Gᵢ=Fᵢ. Encode Gᵢ conditionally given R in a lossless manner. If the byte size of conditionally encoded Gᵢ divided by that of Fᵢ is less than a threshold S, then classify Fᵢ into the sub-category represented by R; else the sub-category represented by R is completed, discard the conditional encoding of Gᵢ, losslessly encode Gᵢ without any help from R if Fᵢ is not compressed, classify Fᵢ into a new sub-category represented by Gᵢ, and update R into R=Gᵢ. Increase i by 1. Completed sub-categories may be further categorized according to side information metadata.

In both Algorithms 2 and 3, each completed sub-category represented by R can be configured to be either a set of files, one file per image Fᵢ classified into the sub-category represented by R, or a single compressed file consisting of several segments with the first segment corresponding to the encoded R and each remaining segment corresponding to the conditionally encoded Gᵢ for each image Fᵢ classified into the sub-category represented by R. Since the conditional encoding of Gᵢ within each sub-category represented by R depends only on R, non-linear editing such as image insertion into, deletion from, and/or extraction from the sub-category represented by R can be easily performed even when the sub-category represented by R is saved as a single compressed file.

When the digital data generating device has enough power supply and the network connections selected by the user are available on the digital data generating device, each encoded Gᵢ along with its categorization information and its metadata containing side information including its locations, occasions, events, features, and other information specified by the user is then automatically and securely transmitted to networks, cloud servers, and/or home and office computers, and is further pushed to other network connected devices.

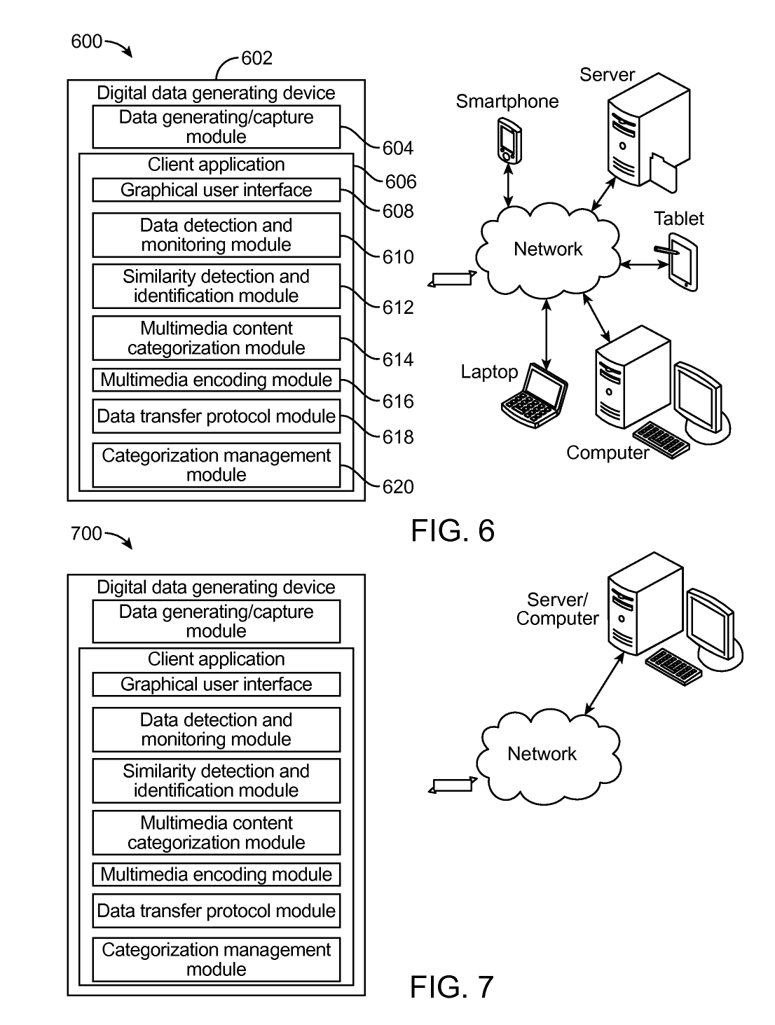

FIG. 6 illustrates the overall architecture of a system 600 in which multimedia data units generated from a network connection enabled digital data generating device 602 are automatically and efficiently categorized in terms of their contents, locations, occasions, events, and/or features, transmitted securely to a cloud server, pushed to other network connected devices, and further managed in sync across all these devices. To describe the system 600 shown in FIG. 6 in details, we once again use images as exemplary multimedia contents. As shown in FIG. 6, a client application 606 is provided on the digital data generating device 602. The client application comprises a graphical user interface (GUI) 608 and six modules: a data detection and monitoring module 610, a similarity detection and identification module 612, a multimedia content categorization module 614, a multimedia encoding module 616, a data transfer protocol module 618, and a categorization management module 620.

The GUI 608 allows a user of the system 600 to configure the system 600 to include the location information provided by the Global Positioning System (GPS) (not shown) for images to be taken and other information such as occasions, events, messages, etc the user can input and wants to be associated with images to be taken, and to select network connections on the digital data generating device 602 for subsequent automatic transmission of these images along with their respective side information data. Later on, the side information data will be used by the system 600 to automatically categorize these images on top of their content similarity.

The data generating/capture module 604 captures data and images on the digital data generating device 602. The data detection and monitoring module 610 detects and monitors this capture process. It will ensure that captured images will flow into subsequent modules along with their respective side information metadata according to the order they have been captured. It also acts as an interface between the data generating/capture module 604 and other modules in the client application 606 by buffering captured images that have not been categorized, encoded or re-encoded, and/or transmitted to the server. As long as the buffer is not empty, the categorization, encoding, and transmission processes will continue whenever the digital data generating device 602 has enough power supply and the network connections selected by the user are available on the digital data generating device 602. Examples of the data generating/capture module 604 include microphones, cameras, videocameras, and 3D versions of cameras and videocameras, which may capture a scene with a 3D effect by taking two or more individual but related images of the scene (representing the stereoscopic views) from different points of view, for example.

Upon receiving a sequence of images F₁, F₂, . . . , Fᵢ, . . . , Fₙ in the order they have been captured, the similarity detection and identification module 612, multimedia content categorization module 614, and multimedia encoding module 616 would function according to Algorithms 1 to 3, as the case may be. Assume that the digital data generating device 602 has enough power supply and the network connections selected by the user are available on the digital data generating device 602. The data transfer protocol module 618 would then automatically and securely transmit each categorized and encoded image along with its categorization information and its associated side information metadata to the server, which in turn pushes its received data to other network connected devices.

Since each categorized and encoded image is compressed, secure transmission can be provided by scrambling a small fraction of key compressed bits, which would reduce the computational complexity and power consumption associated with security in comparison with a full-fledged encryption of all data to be transmitted.

After all categorized and encoded images within a sub-category represented by a representative image R are received by the server along with their categorization information and associated side information metadata, the sub-category represented by R can be configured to be saved as either a set of files, one file per image Fᵢ classified into the sub-category represented by R, or a single compressed file consisting of several segments with the first segment corresponding to the encoded R and each remaining segment corresponding to the conditionally encoded Gᵢ for each image Fᵢ classified into the sub-category represented by R. On the server, completed sub-categories would be further automatically categorized according to their metadata. Through the categorization management module 620 on the digital data generating device 602, the server would send back this change to the digital data generating device 602 and further pushes it to other network connected devices. Further management regarding amalgamation, regrouping, decoupling, insertion, deletion, etc of these encoded and categorized images could also be performed manually on the server, home computers, and/or office computers if needed; changes again will be pushed to all connected devices to keep them in sync with a service agreement.

For each media type—for example, images are one type and video is another type—conceptually, there would be four types of folders to handle all categorized and encoded multimedia data units: an active folder, a permanent folder, a history folder, and a trash folder. Using images as exemplary multimedia contents again, we describe these folders in details. The active folder stores all categorized and encoded images that have been actively accessed by one or more of network connected devices during the past a period of time. This folder would be in sync across all network connected devices including the digital data generating device 602 with the server through the categorization management module 620. Inactive categorized and encoded images would be moved to the permanent folder. The full version of all categorized and encoded images within the permanent folder would be kept in and synced across all network connected devices the user selects for this purpose; for all other network connected devices, only a low resolution version (such as thumbnail version) of all categorized and encoded images within the permanent folder would be kept for information purpose. The history folder would store all images the user has uploaded through the client application to web sites for sharing, publishing, and other multimedia purposes. Finally, the trash folder would store temporarily deleted images, sub-categories, and categories.

FIG. 7 illustrates the overall architecture of a simplified system 700 in which multimedia data units generated from a network connection enabled digital data generating device are automatically and efficiently categorized in terms of their contents, locations, occasions, events, and/or features, transmitted securely to a server/computer, and further managed in sync between the digital data generating device and server/computer. The simplified system 700 is useful when multimedia data units generated from the digital data generating device are intended only to be transferred to the user's own server/computer and managed in sync between the digital data generating device and server/computer. The client application and its corresponding modules on the digital data generating device shown in FIG. 7 have the same functionalities as those in FIG. 6.

Methods for Concurrent Categorization and Lossless Compression

Example methods for concurrent categorization and lossless compression will now be described, in accordance with example embodiments. Using images as exemplary multimedia contents again, in this section, we describe methods for implementing Algorithm 3 in the case in which images Fᵢ, i=1, 2, . . . , n, are JPEG compressed when they are captured by the digital data generating device in the indicated order. Although we focus on Algorithm 3, many steps and procedures presented below also apply to Algorithm 2.

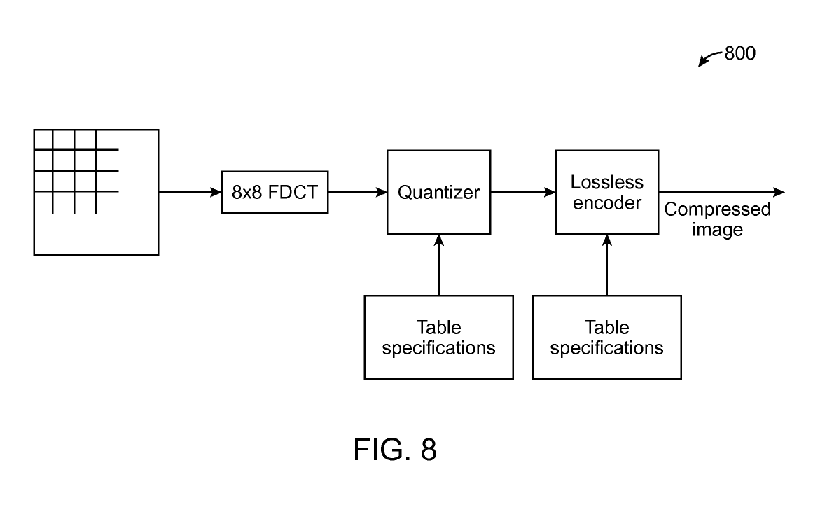

JPEG is a popular discrete cosine transform (DCT) based still image compression standard. It has been widely used in smartphones, tablets, and digital cameras to generate JPEG format images. As shown in FIG. 8, a JPEG encoder 800 consists of three basic steps: forward DCT (FDCT), quantization, and lossless encoding. The encoder first partitions an input image into 8×8 blocks and then processes these 8×8 image blocks one by one in raster scan order (baseline JPEG). Each block is first transformed from the pixel domain to the DCT domain by an 8×8 FDCT. The resulting DCT coefficients are then uniformly quantized using an 8×8 quantization table Q, whose entries are the quantization step sizes for each frequency bin. The DCT indices U from the quantization are finally encoded in a lossless manner using run-length coding and Huffman coding. If the original input image is a multiple component image such as an RGB color image, the pipeline process of FDCT, quantization, and lossless encoding is conceptually applied to each of its components (such as its luminance component Y and chroma components Cr and Cb in the case of RGB color images) independently.

A. Single Component Images

Suppose that each image Fᵢ, i=1, 2, . . . , n, is a JPEG compressed single component image. We first describe methods for implementing key steps in Algorithms 3 in this case.

1) Decode Fᵢ into Gᵢ: With reference to Algorithm 3, since each Fᵢ is JPEG compressed, we need to decode Fᵢ into its reconstruction Gᵢ in the pixel domain. This can be achieved by:

(D1) applying a lossless decoder to Fᵢ to get 8×8 blocks of DCT indices U;

(D2) multiplying each 8×8 block of DCT indices by the 8×8 quantization table Q element-wise to get an 8×8 block of quantized DCT coefficients; and

(D3) applying an integer inverse DCT, say T⁻¹, to each 8×8 block of quantized DCT coefficients to get an 8×8 block of reconstructed pixel values.

All 8×8 blocks of reconstructed pixel values together form the reconstructed image Gᵢ for Fᵢ. Note that Gᵢ here is level-shifted implicitly.

2) Similarity Detection and Identification: With reference to Algorithm 3 again, both Gᵢ and the dynamic representative image R at this point are in the pixel domain. To detect and identify the similarity between Gᵢ and R, we compare Gᵢ against R or a filtered R by first partitioning Gᵢ into blocks of size N×N and then for each of such N×N blocks (hereafter referred to as a target block), searching a region of R or the filtered R to see if there is any N×N block within the searched region which is similar to the target block, where N is an integer multiple of 8 so that each N×N block consists of several 8×8 blocks. If a similar block within the searched region is found, then the block with the strongest similarity in some sense within the searched region is selected as a reference block for the target block. The offset position between the reference block and target block is called an offset vector or motion vector of the target block.

Specifically, let us use the top-left corner of an image as the origin. Then a pixel in the image can be referred to by its coordinates (x, y), where x (y, respectively) increases as we scan the image from left to right (top to bottom, respectively). Consider an N×N target block Bₜ with its upper-left corner at (x, y). Then the search process can be performed as follows:

(S1) In the image R or the filtered R, locate the co-located N×N block to get a starting position (hₘ, jₘ), where the co-located N×N block is the N×N block in R or the filtered R with its upper-left corner at the same position (x, y). If reference blocks in R or the filtered R have been found for one or more neighboring N×N blocks of the target block in Gᵢ, the starting position can also be estimated from the motion vectors of these neighboring blocks. If the co-located block is used as a starting position, then (hₘ, jₘ)=(0, 0).

(S2) Search all N×N blocks Bᵣ in R or the filtered R with their upper-left corners falling into the following set

{(x−hₘ−h, y−jₘ−j):−k≦h, j≦k} (4.1)

where k determines the search range, to see if there is, within the searched region, an N×N block similar to the target block according to some metric.

(S3) If there is, within the searched region, an N×N block similar to the target block, further locate, within the searched region, the N×N block with strongest similarity, say at location (x−hₘ−h*, y−jₘ−j*), which is selected as a reference block for the target block. The offset position (hₘ+h*, jₘ+j*) is the motion vector for the target block.

(S4) If no N×N blocks within the searched region are similar to the target block, select an all zero N×N block as a reference block for the target block and the vector (hₘ+k+1, jₘ) as an artificial offset position.

The similarity metric between an N×N block Bᵣ in R or the filtered R and the target block Bₜ could be based on a cost function defined for the difference Bₜ−Bᵣ; for example, the cost function could be the L₁ norm of Bₜ−Bᵣ

$$C ( {B}_{t} , {B}_{r} ) ) = {\sum }_{a = 0}^{N - 1} {\sum }_{b = 0}^{N - 1} \vert {B}_{t} ( a , b ) - {B}_{r} ( a , b ) \vert \qquad ( 4.2 )$$

or the energy of Bₜ−Bᵣ

$$C ( {B}_{t} , {B}_{r} ) ) = {\sum }_{a = 0}^{N - 1} {\sum }_{b = 0}^{N - 1} {\vert {B}_{t} ( a , b ) - {B}_{r} ( a , b ) \vert}^{2} \qquad ( 4.3 )$$

where for any block B, B(a, b) denotes the value of the pixel located at the ath column and bth row of B. The similarity metric between Bᵣ and Bₜ could also be based on a cost function defined for

$$round ( \frac{T ( {B}_{r} )}{Q} ) and \\ round ( \frac{T ( {B}_{t} )}{Q} ) \qquad ( 4.4 )$$

where T denotes the forward DCT corresponding to the integer inverse DCT T⁻¹ and is applied to every 8×8 block, the division by Q is an element-wise division, and so is the round operation. No matter which similarity metric or cost function is used, Bᵣ is similar to Bₜ if C (Bₜ, Bᵣ)−C(Bₜ, 0) is less than a threshold, where 0 denotes the all zero N×N block; otherwise, Bᵣ is deemed not to be similar to Bₜ.

Mean-based search: When the search region is large, i.e., when k in (4.1) is large, the computation complexity of Step S2 would be very large if the brute force full search is adopted. To reduce the computation complexity of Step S2, we here describe an efficient mean-based search method:

(S2-1) Calculate the mean of the target block Bₜ, i.e., the mean value of all pixel values within the target block Bₜ. Since Gᵢ is obtained from the PEG compressed Fᵢ via Steps D1 to D3, it is not hard to see that the mean of the target block Bₜ can be easily computed as the average of the quantized DC coefficients (from Fᵢ) of all JPEG 8×8 blocks contained within the target block Bₜ.

(S2-2) Calculate the mean of each N×N block Bᵣ in R or the filtered R with its upper-left corner falling into the set given by (4.1). For overlapped blocks Bᵣ, their means share a significant number of common pixel values. By avoiding repeated computations, the means of all N×N blocks Bᵣ in R or the filtered R with their upper-left corners falling into the set given by (4.1) can be computed with (4 k+N)²−1 additions. This is compared very favorably with (2 k+1)²(N²−1) additions, which are required if the mean of each N×N block Bᵣ with its upper-left corner falling into the set given by (4.1) is computed independently and one by one.

(S2-3) Search only those N×N blocks Br in R or the filtered R whose upper-left corners fall into the set given by (4.1) and whose means are close to the mean of the target block Bt, to see if there is an N×N block similar to the target block according to the selected similarity metric. Those N×N blocks Br in R or the filtered R whose upper-left corners fall into the set given by (4.1), but whose means are away from the mean of the target block Bt, will be skipped.

3) Lossless conditional encoding of Gᵢ given R: Apply the procedure specified in Steps S1 to S4 to each and every target block in Gᵢ. We then get a reference block for each and every target block in Gᵢ. Let Pᵢ be the image obtained by piecing all these reference blocks together in the same order as their corresponding target blocks would appear in Gᵢ. The image Pᵢ is called a predicted image for Gᵢ from R. Since Pᵢ is determined by comparing Gᵢ against R, the decoder does not know at this point what Pᵢ is. As such, one has to first encode in a lossless manner all motion vectors of all target blocks in Gᵢ and then send the resulting compressed bits to the decoder. Upon receiving these compressed bits, the decoder can recover Pᵢ perfectly with help of R. The lossless encoding of Gᵢ given R can then be achieved by encoding Gᵢ conditionally given Pᵢ in a lossless manner. Note that both Gᵢ and Pᵢ are implicitly level shifted.

A typical approach to encoding Gᵢ conditionally given Pᵢ is to encode the difference image Gᵢ−Pᵢ⁻ without any loss. However, although conceptually simple and popular, such an approach is not efficient in our case. Indeed we can do much better by providing a technique dubbed lossless encoding via quantization, which is described next.

Lossless encoding via quantization: Since Gᵢ is obtained from the JPEG compressed Fᵢ via Steps D1 to D3, it is not hard to see that

$$\begin{matrix}U = \frac{T ( {G}_{i} )}{Q} \\ and & ( 4.5 ) \\ \begin{matrix}round ( \frac{T ( {G}_{i} - {P}_{i} )}{Q} ) = round ( \frac{T ( {G}_{i} )}{Q} ) - round ( \frac{T ( {P}_{i} )}{Q} ) \\ = U - round ( \frac{T ( {P}_{i} )}{Q} )\end{matrix} & ( 4.6 )\end{matrix}$$

where U is the sequence of DCT indices decoded out from Fᵢ, T denotes the forward DCT corresponding to the integer inverse DCT T⁻¹ and is applied to every 8×8 block, the division by Q is an element-wise division, and so is the round operation. In view of (4.5), U and Gᵢ can be determined from each other. In addition, the JPEG compressed Fᵢ can be fully recovered without any loss from either U or Gᵢ. Therefore, it follows from (4.6) that lossless encoding of Gᵢ or U can be achieved by lossless encoding of the quantized, transformed difference image

$$round ( \frac{T ( {G}_{i} - {P}_{i} )}{Q} ) . \\ by adding$$

$$round ( \frac{T ( {P}_{i} )}{Q} )$$

which can also be computed by the decoder, to the quantized, transformed difference image, we get U back without any loss. In comparison with the direct lossless encoding of the difference image Gᵢ−Pᵢ in either the pixel domain or transform domain, the lossless encoding via quantization technique through the lossless encoding of the quantized, transformed difference image is more efficient since the energy of the quantized, transformed difference image is drastically reduced. Note that the quantization table Q used to quantize the transformed difference image T (Gᵢ−Pᵢ) should be identical to that used to generate the JPEG compressed Fᵢ by the digital data generating device when Fᵢ was first captured.

Variants of lossless encoding via quantization: One variant of the lossless encoding via quantization technique mentioned above is to directly encode U in a lossless manner with help of

$$round ( \frac{T ( {P}_{i} )}{Q} ) . \qquad ( 4.7 )$$

In this case, there are some flexibilities in the quantization process used in (47). In particular, the quantization process used in (4.7) may not be identical to that used to generate the JPEG compressed Fᵢ by the digital data generating device when Fᵢ was first captured. For example, if most DCT coefficients in an 8×8 block in T (Gᵢ) have values greater, by a margin q, than corresponding DCT coefficients in a corresponding 8×8 block in T (Pᵢ), then all DCT coefficients in the corresponding 8×8 block in T (Pᵢ) can be shifted to the right by q before they are quantized so that after quantization, they are closer to DCT indices U corresponding to the 8×8 block in T (Gᵢ).

4) Concurrent categorization: After the lossless conditional encoding of Gᵢ or U given R is completed, the decision regarding whether Fᵢ should be assigned to the sub-category represented by R can be based on the total number of compressed bits resulting from the lossless encoding of all motion vectors of all target blocks in Gᵢ and from the lossless conditional encoding of Gᵢ or U given Pᵢ in comparison with the total number of bits in the JPEG compressed Fᵢ. If the former divided by the latter is less than a threshold, say S, then assign Fᵢ into the sub-category represented by R. Otherwise, assign Fᵢ into a new sub-category represented by R=Gᵢ.

8. Multiple Component Images

Suppose now that each image Fᵢ, i=1, 2, . . . , n, is a JPEG compressed multiple component image; further the number of components and their types are the same for all i=1, 2, . . . , n. For example, when an RGB color image is compressed by JPEG, it is first converted from the RGB color space to the YCrCb space; if the 4:2:0 format is adopted, its chroma components Cr and Cb are further downsmapled; then its luminance component Y and downsampled chroma components Cr and Cb are compressed independently by a JPEG encoder and multiplexed together to form a JPEG compressed color image.

In this case, the methods described in the herein subsection “A. Single Component Images” are applied to each component independently except for the following example possible changes:

(C1) To reduce the computation complexity of Steps S1 to S4 and also the number of compressed bits needed for the lossless encoding of the resulting motion vectors, different components can share the motion vectors of their target blocks. Take JPEG compressed color images i=1, 2, . . . , n as an example. Once the motion vector of a target block in the luminance component Y of Fᵢ (more precisely, Gᵢ) is determined, it or its scaled version could be used as the motion vector of the corresponding target blocks in both Cr and Cb chroma components of Fᵢ.

(C2) In the concurrent categorization step, the decision regarding whether Fᵢ should be assigned to the sub-category represented by R can be based on either a single component of Fᵢ or all components of Fᵢ together. Once again, take JPEG compressed color images Fᵢ, i=1, 2, . . . , n as an example. One can assign Fᵢ into the sub-category represented by R if the total number of compressed bits resulting from the lossless encoding of all motion vectors of all target blocks in the luminance component Y of Gᵢ and from the lossless conditional encoding of the luminance component Y of Gᵢ given the luminance component Y of Fᵢ is less than the total number of bits in the JPEG compressed luminance component Y of Fᵢ multiplied by a threshold S. Alternatively, one can assign Fᵢ into the sub-category represented by R if the total number of bits in the conditionally encoded Gᵢ (including all of its components) given R is less than the total number of bits in the JPEG compressed Fᵢ (including all components of Fᵢ) multiplied by a threshold S.

In accordance with an example embodiment, there is provided a method for managing multimedia content of a device having access to a plurality of successive media data units, the method including: comparing media data units within the plurality of successive media data units to determine similarity, and when the determined similarity between compared media data units is within a similarity threshold, automatically categorizing the compared media data units within the same category.

In accordance with another example embodiment, there is provided a method for encoding media content of a device having access to a plurality of successive media data units, the method including: encoding a selected media data unit of the plurality of successive media data units in dependence on a reference media data unit, and when resulting compression efficiency is not within a compression threshold, referencing the selected media data unit as the reference media data unit.

There may also be provided the method of the another example embodiment, wherein the encoding comprises conditionally encoding, wherein the method further comprises discarding the conditional encoding when the resulting compression efficiency is not within the compression threshold.

There may also be provided the method of the another example embodiment, further comprising the device generating at least one of the plurality of successive media data units.

There may also be provided the method of the another example embodiment, wherein the generating is implemented from a media capturing component of the device.

There may also be provided the method of the another example embodiment, further comprising performing said selecting on the media data units in succession, and performing said referencing when resulting compression efficiency is not within the compression threshold.

There may also be provided the method of the another example embodiment, further comprising, when resulting compression efficiency is within a compression threshold, automatically categorizing the selected media data unit and the reference media data unit within the same category.

There may also be provided the method of the another example embodiment, wherein the multimedia data units each have associated side data specifying for the multimedia data unit at least one of a location, occasion, event and feature; wherein automatically categorizing the compared media data units includes sub-categorizing multimedia units that are within the same category according to the side data.

There may also be provided the method of the another example embodiment, wherein the reference media data unit is initialized as a blank media data unit or a previous media data unit.

There may also be provided the method of the another example embodiment, wherein the referencing further comprises copying the reference media data unit to a file.

There may also be provided the method of the another example embodiment, further comprising, prior to the encoding of any one of the media data units, decoding the any one of the media data units which is in an encoded format.

There may also be provided the method of the another example embodiment, further comprising, after referencing the selected media data unit, re-encoding, without dependence on the reference media data unit, the selected media data unit which did not require decoding.

There may also be provided the method of the another example embodiment, wherein the multimedia data units each correspond to one image, one video frame or one audio frame.

There may also be provided the method of the another example embodiment, wherein the device is network connection enabled, the method further comprising, when a preselected network connection is available, automatically transmitting the categorized multimedia data units to one or more remote computing devices.

There may also be provided the method of the another example embodiment, wherein the automatically transmitting is part of a synchronizing process between the device and the one or more remote computing devices.

In accordance with an example embodiment, there is provided a device, including memory, a component configured to access a plurality of successive media data units, and a processor configured to execute instructions stored in the memory in order to perform the described methods.

In an example embodiment, the device further comprises a media capturing component configured to generate the plurality of successive media data units.

In an example embodiment, the device further comprises a component configured to enable network connectivity.

In an example embodiment, the memory stores the plurality of successive media data units.

In accordance with an example embodiment, there is provided a non-transitory computer-readable medium containing instructions executable by a processor for performing the described methods.

In the described methods, the boxes may represent events, steps, functions, processes, modules, state-based operations, etc. While some of the above examples have been described as occurring in a particular order, it will be appreciated by persons skilled in the art that some of the steps or processes may be performed in a different order provided that the result of the changed order of any given step will not prevent or impair the occurrence of subsequent steps. Furthermore, some of the messages or steps described above may be removed or combined in other embodiments, and some of the messages or steps described above may be separated into a number of sub-messages or sub-steps in other embodiments. Even further, some or all of the steps may be repeated, as necessary. Elements described as methods or steps similarly apply to systems or subcomponents, and vice-versa. Reference to such words as “sending” or “receiving” could be interchanged depending on the perspective of the particular device.

While some example embodiments have been described, at least in part, in terms of methods, a person of ordinary skill in the art will understand that some example embodiments are also directed to the various components for performing at least some of the aspects and features of the described processes, be it by way of hardware components, software or any combination of the two, or in any other manner. Moreover, some example embodiments are also directed to a pre-recorded storage device or other similar computer-readable medium including program instructions stored thereon for performing the processes described herein. The computer-readable medium includes any non-transient storage medium, such as RAM, ROM, flash memory, compact discs, USB sticks, DVDs, HD-DVDs, or any other such computer-readable memory devices.

Although not specifically illustrated, it will be understood that the devices described herein include one or more processors and associated memory. The memory may include one or more application program, modules, or other programming constructs containing computer-executable instructions that, when executed by the one or more processors, implement the methods or processes described herein.

The various embodiments presented above are merely examples and are in no way meant to limit the scope of this disclosure. Variations of the innovations described herein will be apparent to persons of ordinary skill in the art, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

All publications described or referenced herein are hereby incorporated by reference in their entirety.

What is claimed is:

1. A method for managing multimedia content of a device having access to a plurality of successive media data units, the method comprising:
comparing media data units within the plurality of successive media data units to determine similarity; and
when the determined similarity between compared media data units is within a similarity threshold, automatically categorizing the compared media data units within the same category.

2. The method of claim 1 further comprising the device generating at least one of the plurality of successive media data units.

3. The method of claim 1 wherein the generating is implemented from a media capturing component of the device.

4. The method of claim 1 wherein comparing media data units comprises comparing content similarity between the media data units.

5. The method of claim 1 further comprising referencing one of the media data units as a reference media data unit.

6. The method of claim 5 wherein the comparing comprises comparing, in succession, each of the media data units with the reference media data unit.

7. The method of claim 6 further comprising, when one of the compared media data units is not within the similarity threshold, referencing the one of the compared media data units as the reference media data unit.

8. The method of claim 6 further comprising, when the determined similarity of a compared media data unit to the reference media data unit is within the similarity threshold, encoding the compared media data unit in dependence on the reference media data unit.

9. The method of claim 6 further comprising encoding, when the determined similarity of a compared media data unit to the reference media data unit is not within the similarity threshold, without dependence on the reference media data unit, the compared media data unit which is not already in an encoded format.

10. The method of claim 5 wherein the reference media data unit is initialized as a blank media data unit or a previous media data unit.

11. The method of claim 8 further comprising grouping, in succession, each of the encoded and compared media data units together with the reference media data unit.

12. The method of claim 5 wherein the similarity threshold is a compression threshold, and wherein the comparing media data units comprises conditionally encoding a selected media data unit in dependence on the reference media data unit and the determined similarity being determined when the resulting compression efficiency is within a compression threshold.

13. The method of claim 1 further comprising, prior to comparing of any one of the media data units, decoding the any one of the media data units which is in an encoded format.

14. The method of claim 1 wherein the multimedia data units each correspond to one image, one video frame or one audio frame.

15. The method of claim 1 wherein the multimedia data units each have associated side data specifying for the multimedia data unit at least one of a location, occasion, event and feature; wherein automatically categorizing the compared media data units includes sub-categorizing multimedia units that are within the same category according to the side data.

16. The method of claim 1 wherein the device is network connection enabled, the method further comprising, when a preselected network connection is available, automatically transmitting the categorized multimedia data units to one or more remote computing devices.

17. The method of claim 16, further comprising automatically transmitting the categorized multimedia data units from the one or more remote computing devices to one or more further digital data generating devices.

18. The method of claim 16, wherein the automatically transmitting is part of a synchronizing process between the device and the one or more remote computing devices.

19. A device, comprising:
memory;
a component configured to access a plurality of successive media data units; and
a processor configured to execute instructions stored in the memory in order to:
compare media data units within the plurality of successive media data units to determine similarity, and
when the determined similarity between compared media data units is within a similarity threshold, automatically categorize the compared media data units within the same category.

20. The device of claim 19 further comprising a media capturing component configured to generate the plurality of successive media data units.

21. The device of claim 19, wherein the memory stores the plurality of successive media data units.

22. A non-transitory computer readable medium containing instructions executable by a processor of a device for managing media content of the device, the instructions comprising:
instructions for comparing media data units within the plurality of successive media data units to determine similarity; and
instructions for, when the determined similarity between compared media data units is within a similarity threshold, automatically categorizing the compared media data units within the same category.
